(19) United States
(12) Patent Application Publication
(10) Pub. No.: US 2018/0238304 A1
(43) Pub. Date: Aug. 23, 2018

(54) DISTRIBUTED COMPRESSED AIR ENERGY STORAGE WITH HEAT NETWORK

(71) Applicant: Eronini Iheanyi UMEZ-ERONINI, Washington, DC (US)

(72) Inventor: Eronini Iheanyi UMEZ-ERONINI, Washington, DC (US)

(21) Appl. No.: 15/550,164

(22) PCT Filed: Apr. 9, 2016
(86) PCT No.: PCT/US2016/026841

§ 371 Date: Aug. 10, 2017

Related U.S. Application Data
(60) Provisional application No. 62/116,564, filed on Feb. 16, 2015.

(51) Int. Cl. F03D 9/18; F03D 9/17; F03D 7/04; F03D 9/25; F03D 13/25

(52) U.S. Cl. CPC F03D 9/18; F03D 9/17; F03D 7/048; F03D 9/257; F05B 2270/303; F05B 2240/95; F05B 2260/205; F05B 2270/1033; F03D 13/25

(57) ABSTRACT

A method and system of distributed Compressed Air Energy Storage with thermal energy interchange network of cooling and heating circuits and dynamically scheduled power production, energy storage and power generation from storage, of integrated individual power resources to enhance system thermal efficiency and capacity factor.

### TECHNICAL FIELD

The invention relates generally to a method and system to improve the capacity factor of energy resources characterized by distributed intermittent power sources, such as wind turbines in a wind farm, by thermally efficient energy storage in compressed air. More specifically the invention relates to distributed compressed air energy storage with a heat interchange network for high thermal efficiency.

### BACKGROUND ART

Intermittency and availability of wind and related energy resources are typically at variance with power demand resulting in under-utilization and modest intrinsic capacity factors for such power sources. The problem of intermittency and availability of some energy resources may be mitigated by incorporation of energy storage systems to accumulate energy during off-peak power demand and release the energy during peak power demand. Compressed Air Energy Storage devices store energy by using an electric motor to compress air which is then stored and later used to generate electricity by expanding the compressed air through turbines. Compressed air energy storage systems have limited environmental impact and operational constraints, are long lived, and represent mature and reliable technology with high power capture advantages over most other energy storage approaches to mitigating the intermittency and availability problem of wind resources. Conventional Compressed Air Energy Storage employing large scale underground formations for air storage can boost current capacity factors of wind turbines of on-land wind farms by almost a factor of two. Unfortunately favorable geologic resources are usually not available collocated or in close proximity with most offshore wind and some other power resources.

Although conventional Compressed Air Energy Storage systems have limited system efficiency due mostly to thermal energy losses in the compressor and expander trains which operate on different schedules, they possess very high economics of scale, and reliability that derives from use of proven conventional turbomachinery. Related technologies with potentially higher thermal system efficiencies than conventional Compressed Air Energy Storage systems, such as various “near” isothermal compressor-expander Compressed Air Energy Storage technology that utilize new compressor and expander systems (for example United States Patents Bolinger 2010: U.S. Pat. No. 7,802,426 and Fong et al 2012: U.S. Pat. No. 8,182,240), must undergo long and extensive development before the elements approach the functional and reliability levels of conventional Compressed Air Energy Storage components.

Conventional compressed air energy storage systems also have advantages including: the compression time can be optimized to market conditions; operational flexibility; scalability; low emission, since only supplemental heating may be needed; flexible equipment sourcing—combustion and expansion turbines and air compressors are standard industry components; lowest capital cost per kilowatt hour delivered for bulk storage, among competing technologies—pumped hydro, flywheels, batteries, super-capacitor, magnetic, thermal, etc. While batteries are also cost effective, abuse tolerant, and critical for the electrification of personal transportation systems, they lack the brute capacity required for most wind power regulation.

It is an object of the present invention to facilitate high thermally efficient compressed air energy storage system utilizing conventional components.

### DISCLOSURE OF INVENTION

Current Compressed Air Energy Storage employing large scale underground air storage or otherwise consolidated air storage have compression chain technology that uses intercoolers and an aftercooler to reduce the temperature of the injected air thereby enhancing the compression efficiency, reducing the storage volume requirement and minimizing thermal stress on the storage volume walls. With a large number of compressor stages and intercooling the system theoretical efficiency can approach that for adiabatic compression. Conventional turbo expander chains require fuel to be combusted to heat the compressed air during expansion to improve the process capacity and efficiency. Additional approaches to improve efficiency and boost capacity include turbine blade cooling, humidification, and steam injection schemes. However both cooling of the compressed air during compression and heating it during expansion represent significant loss of energy because the heat generation and heat utilization are essentially separated in-time to off-peak hours and peak demand hours. The use of equally consolidated long-term thermal energy storage which is fraught with inefficiencies is only marginally effective in alleviating the energy loss. Also the electrical energy generation per unit of air storage capacity is dependent on the compressed air supply pressure and consolidated or underground (aquifer) air storage systems have limited pressure capacity due to physical considerations.

The present invention comprises of a method and system that retains all the proven components and relevant capacity improvement options of conventional Compressed Air Energy Storage but (1) distributes the air storage, compression and expansion to a multiplicity of storage tanks and compressor-expander trains at each wind turbine (intermittent power source) in a farm; the much reduced size turbine based storage tanks may operate at much higher pressures than is feasible with geologic formations and large consolidated storage means thus overcoming the loss of economy of scale in the distributed system, (2) includes a thermal energy interchange network linking all the turbine stations with well insulated controlled cooling and heating circuits, (3) includes distributed and central or supervisory control functions to dynamically schedule individual wind turbine power production or energy storage or compressed air power production, in concert with regular wind farm operational objectives, including optimization of system thermal efficiency and capacity factor; and (4) integrates the items 1-3 functionally and physically with the wind farm or distributed intermittent power resource.

Efficiency and capacity improvements result from the matching of heat production of the energy-storing turbines with the heat demand of the turbines producing power from stored energy. The compression and expansion phases of each turbine station is no longer directly coupled to the global off-peak and peak power demand cycle, and the conventional fuel requirement during expansion is grossly reduced or eliminated but without the attendant need for formal long-term thermal energy storage due to advanced management of the thermal energy interchanges in the heat network, The optimal scheduling of the turbines' energy storage and power production and generation phases is in addition to the other complex objectives of power and load control of the wind farm. Wind turbines are spread over a large area, and not all turbines encounter the same transient wind conditions. Moreover the layout of turbines on the farm, whether dictated by geographical features, prevailing wind direction or other factors introduce turbine aerodynamic interaction into the control mix. Separation of the compression and turbo-expander components and operations implies that the compressor size can be optimized independently of the turbo-expander design and standard production compressors may be used in the system configuration.

### BRIEF DESCRIPTION OF THE DRAWINGS

These features and advantages of the invention are made more apparent when considered in connection with the accompanying drawings conveying application of a preferred embodiment to an offshore wind farm, as an example, which is not to be considered limiting its scope to other embodiments or applications which the invention is capable of contemplating. These drawings which are not to scale or exact shape or form, omit for clarity, routine items of structure, equipment, software and hardware, including those for annunciation, sensing and control, that are obvious to one skilled in the art, while illustrating the method and system of the invention according to:

FIG. 1 is a general view of an exemplary offshore wind turbine including the tower and support;

FIG. 2 illustrates in general vertical cross-section the tower and support with the corresponding units of distributed air storage tank, compression and expansion units, and branch elements of the cooling and heating circuits; and

FIG. 3 illustrates a general plan view or layout of the wind farm with the thermal energy interchange network of insulated cooling and heating circuits interposed with the usually buried or covered electric power cables on the sea floor.

### BEST MODE FOR CARRYING OUT THE INVENTION

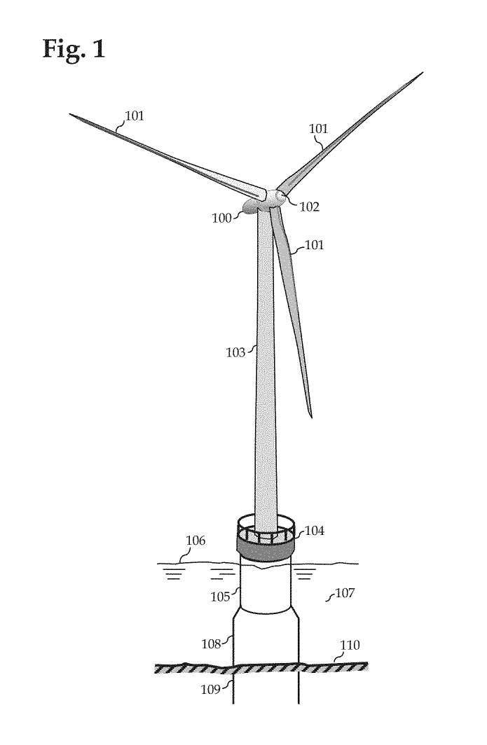

FIG. 1 depicts generally an individual wind turbine out of the many that would compose a wind farm. In the figures, like numerals indicate like or corresponding components throughout. Accordingly, the offshore wind turbine components include the turbine which consists of the nacelle 100, the rotor with the blades 101, and the hub 102. The rotor is connected through a drive train to the generator which is housed in the nacelle. Various sensors and control actuators such as for pitch and yaw controls (not shown) may be included in the nacelle and hub. The nacelle, blades and hub are mounted at the top of the tower 103, which incorporates a platform 104, connected to a transition piece 105, The platform is disposed sufficiently above the sea surface 106, but part of the transition piece 105 is typically below the sea surface and in the water 107. The transition piece connects to the foundation structure, a type of which is the monopile 108 illustrated in the figure. A sufficient in length segment of the monopile 109 is embedded into the sea bed 110 to provide a secure foundation.

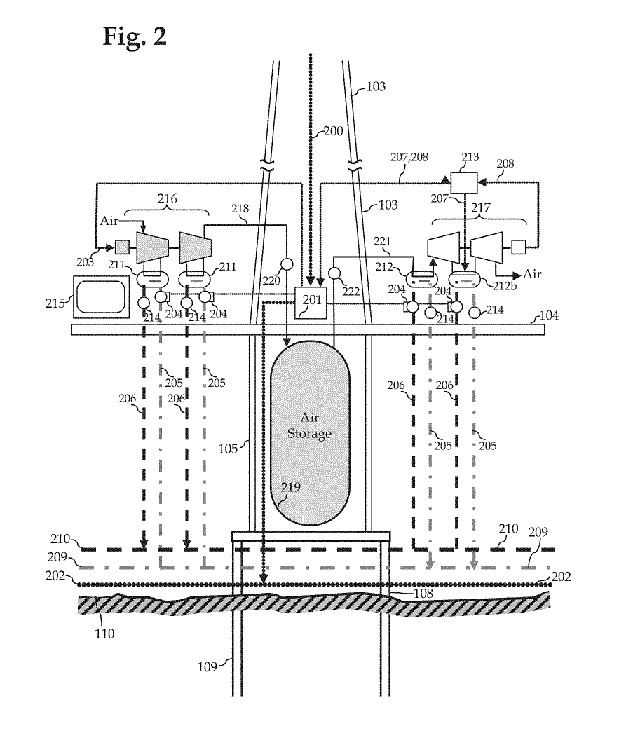

Referring to FIG. 2, the power generated by the turbine is transmitted by cable 200, to the turbine transformer or power control unit 201. The turbine power control unit typically steps up the voltage of the generated power and connects it to the inner-array electric power cable 202, which enters and exits the foundation near the mud line. Under the present embodiment of the invention, the turbine power control unit functions also include appropriate power supply 203 to the compressor; appropriate power supply to local pump/flow controls 204 in that turbine's branch cooling circuit 205 and branch heating circuit 206; appropriate power supply 207, if necessary, to the reheaters 212b, and reception and conditioning of generated-from-storage power 208. Because the cooling circuit 209 and heating circuit 210 lines are under their operating pressures, the local pump/flow controls are needed to circulate cool fluid from the cooling circuit through the compressor after cooler, if any (not shown) and the intercoolers 211, and regulate the flows; and to circulate hot fluid from the heating circuit through any preheater 212 and reheaters 212b, and regulate the flows. The cooled fluid exiting any preheater 212 and reheaters 211b enter the cooling circuit 209, while the heated fluid exiting the intercoolers 211 enter the heating circuit 210, The power circuits may include additional sub-control units such as 213. The branch thermal circuits may also include necessary additional flow controls such as check valves, et cetera, illustrated generally in FIG. 2 by the devices 214.

FIG. 2 also illustrates generally the distributed or local system control system 215, the compressor train 216, and the expander/generator train 217. All these units 215-217, flow devices 204, 214, power controls 201,213, and associated structures and accessories are contained on a platform 104 which may be the same or separate from the general work platform 104 indicated in FIG. 1. Compressed air 218 leaving the compressor train 216, enter the air storage tank 219 through a complement of flow and pressure control devices 220. Compressed air supply 221 to the expander/generator′ train 217, exit the air storage 219 through a complement of flow and pressure control devices 222. FIG. 2 also shows the air storage tank 219 fully contained in the transition piece 105. However, depending on its size, operating pressure, and material of construction, the air storage may be contained in one or more of the support elements, that is, the monopile or foundation piece 109, the transition piece 105 and the tower 103. For example at a storage pressure of about 80 bar and depending on the turbine inlet pressure regulation adopted, roughly 2500 m³ of storage volume may be needed to produce 20 MWh of energy, assuming adiabatic compression. This volume can be accommodated within approximately 60 m length of a 7.3 m internal diameter cylindrical storage vessel (excluding internal structural elements).

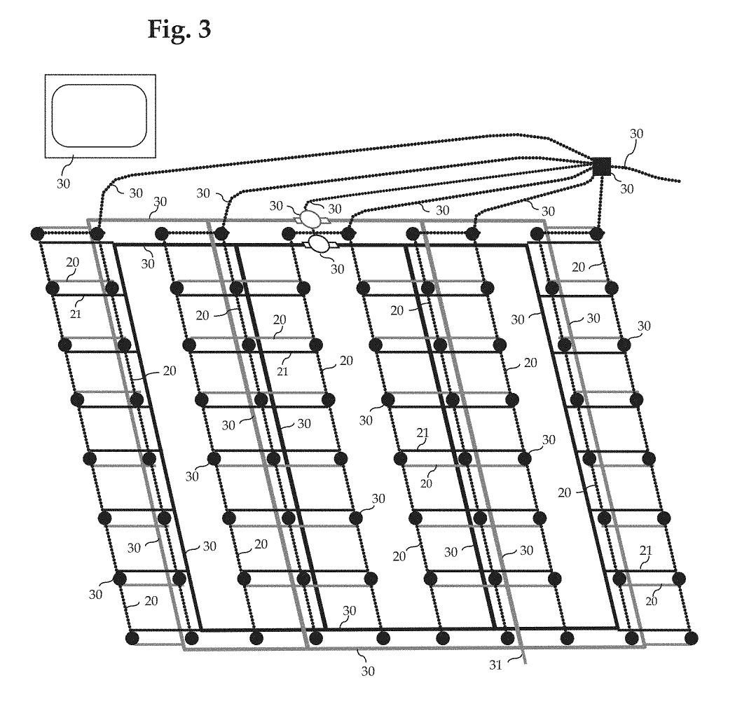

Referring to FIG. 3, an illustrative distribution of wind turbine units 300 is shown. It is understood that offshore wind farm layouts vary in pattern and number of turbine units constituting the farm. The turbine units are linked in strings by inner-array cables 202, previously described. The strings link to the farm substation or switch yard 301 via the outer-array cables 302, and power leaves the wind farm or connects to the onshore transmission system via the export cable 303. Typically the farm power cables are buried or covered on the sea floor. As shown in FIG. 3, the thermal energy interchange network of cooling circuits 209 and heating circuits 210 may also be deployed on the sea floor, so that certain physical attributes and installation of the heat interchange network may be akin to the layout and deployment of the power cable network. However the detailed pattern of the thermal network, which is optimized for fluid power losses, could be different from the illustration in FIG. 3 but is still constrained by the wind farm layout and the number of wind turbine units. The thermal energy networks illustrated in FIG. 3 incorporate circuit headers 304 and 305, which respectively, distribute the cool and hot fluids to the cooling and heating circuits, 209 and 210. The flow through the cooling and heating headers and pressure and thermal mixing in the cooling and heating circuits are maintained by pumping stations and associated flow and pressure control devices, illustrated generally in FIG. 3 by pumps 306 and 307 respectively. FIG. 3 also illustrates generally, the central or supervisory control systems for the wind farm and distributed compressed air energy storage with heat networks system 308. The thermal energy network drives 306 and 307, are centrally powered 309, and centrally controlled in the control systems 308, The thermal circuits are closed loops, with possible occasional make-up of fluid 310, in the cool fluid loop. The circulating fluids could be sea water, given the environment of the offshore wind intermittent power resource embodied in this description, however such application is not to be considered in any way limiting to this invention.

### INDUSTRIAL APPLICABILITY

The exploitation of the invention by industry is obvious from the nature of the invention and the description here-in of a preferred embodiment. However, separate considerations may apply for new wind farms and existing wind farms. For a new wind farm, the design of the wind turbine tower and support would consider the air storage high pressure tank 219, if it is to be incorporated within the tower and support structure. Similarly the expanded utility of the tower platform 104 would be taken into account in its design. For existing wind farms, the air storage tank 219, and the compressor 216 and expander/generator 217 trains may be incorporated, if feasible, in the wind turbine tower and support through appropriate retrofits and reinforcements of these structures or otherwise contained in appropriately designed additional offshore structure contiguous with each wind turbine unit. For both new and existing wind farms, the thermal energy interchange network of cooling circuits 209 and heating circuits 210 may be composed of uninsulated and insulated undersea flow pipes and accessories, utilizing established technology for offshore oiligas production subsea substations and pipeline systems.

The wind farm management and operation control system requires significant changes from conventional wind farm control systems. Ordinarily, this is a hierarchical system of a farm level controller 308, and turbine level controller 215. The turbine level control, in turn, could be in three levels: turbine supervisory control, operational control and subsystem control, which ensure various actuators, yaw drive, pitch drives, the generator, and the power electronics realize and maintain their set points. The typical objective of the farm level controller is control of the farm generated power which may need to track some external power demand; and coordinated control of the power production by individual farm turbines to mitigate variations in wind flow conditions at turbine sites and aerodynamic interactions of the turbines. With typical turbine operations in four regimes: (1) turbine not run—wind speed below cut-in speed, (2) turbine run with speed control—wind speed above cut-in speed but below allowable value for high rotor speed, (3) turbine run under power-limited control for safe electrical and mechanical loads—wind speed above allowable value for high rotor speed but below furling wind speed, and (4) turbine shut down—wind speed at or above furling speed; the turbine supervisory controller typically determines when the turbine is started or stopped and conducts turbine health monitoring tasks, while the turbine operational controller regulates turbine operation in regimes 2 and 3. In exploiting the invention, the turbine subsystem controls multiply to include the additional components associated with the compressor and expander/generator trains and the air storage tank; the farm level controller objectives expand to include regulation of flow and energy interchange in the heat network and optimization of thermal efficiency throughout the farm. The “operation” regimes of each turbine station (this includes when turbine is not run or when turbine is shut down) become elaborated, with each regime incorporating combinations of (a) turbine “operation” without compressed air energy storage and compressed air power production, (b) turbine “operation” with compressed air energy storage, and (c) turbine “operation” with compressed air power production. The turbine supervisory controller functions and objectives are accordingly elaborated.

What is claimed is:

1. A method and system of compressed air energy storage to improve the capacity factor of distributed intermittent power sources such as wind turbines on a wind farm, comprising of:
distributing the air storage, compression and expansion to a multiplicity of storage tanks and compressor-expander trains at each wind turbine or intermittent power source,
providing a thermal energy interchange network linking all the power source or turbine stations with insulated and controlled cooling and heating circuits, and
includes supervisory farm level controls and distributed turbine level controls which dynamically schedule individual turbine power production and or compressed air energy storage or compressed air power production in concert with the energy farm operational objectives and optimization of thermal efficiency and capacity factor for the farm.

2. The method and system of claim 1, wherein the turbine power sources, the distributed air storage, compression and expansion systems, the thermal energy interchange network and the control systems are integrated and function as a system for demand power production at optimal thermal efficiency, with:
generated power from turbines utilized for farm power including demand power satisfaction, air compression, and driving the cooling and heating circuits,
generated power from compressed air is also utilized for farm power,
heat produced during air compression is captured in the heat interchange network, and
heat demand during air expansion is met by the heat interchange network.

3. The method and system of claim 1, wherein a hierarchical control system includes in the farm level controls regulation of fluid flow and energy interchange in the heat network and optimization of thermal efficiency in the farm; and the operational regimes implemented by the turbine station level controls are elaborated to encompass combinations of (1) turbine operation (not run, run during wind speeds above cut-in speed and below allowable wind speed for high rotor speed, run during wind speeds above allowable wind speed for high rotor speed but below furling wind speed, and turbine shut down for safety considerations), (2) compressed air energy storage, and (3) compressed air power production.

4. The method and system of claim 1, wherein the distributed air storage, compression and expansion systems may also incorporate proven and available components and capacity improvement options of conventional compressed air energy storage and power production systems.

5. The system of claim 2, wherein the air storage, compression and expansion, comprising of the air storage tank, compressor train and expander/generator train, with their accessories, including after coolers, intercoolers, preheaters, and reheaters, flow devices, power electronics and control systems, may be incorporated within the turbine tower and support structures such as the platform, the transition piece and foundation piece.

6. The system of claim 2, wherein the heat interchange network is comprised of a network of uninsulated and insulated pipes on the sea bed or covered or buried in the sea floor, and linking the compressed air compressor intercoolers and after coolers and the compressed air expander preheaters and reheaters to constitute heating and cooling circuits, with the necessary complement headers, pumping stations, flow and pressure control devices.

7. The system of claim 2, wherein the turbine stations are linked by a network of inner-array electric power cables on the sea bed or covered or buried in the sea floor, and linking each wind turbine through its power control unit; a set of outer-array cables; a wind farm substation or switch yard; and controls and accessories to gather and transmit externally power generated by the farm.

8. The system of claim 4, wherein the reduced size air storage tanks may operate at higher pressures than feasible for large consolidated or underground formation compressed air storage.
